(19) United States
(12) Patent Application Publication
(10) Pub. No.: US 2021/0056593 A1
(43) Pub. Date: Feb. 25, 2021

(54) AUTOMATED RESEARCH SYSTEM, PROCESSES, AND METHODS OF USE

(71) Applicant: Timothy K. Stohlman, Dallas, TX (US)

(72) Inventor: Timothy K. Stohlman, Dallas, TX (US)

(21) Appl. No.: 16/907,145

(22) Filed: Jun. 19, 2020

Related U.S. Application Data
(60) Provisional application No. 62/890,260, filed on Aug. 22, 2019.

(51) Int. Cl. G06Q 30/02; G06Q 30/06

(52) U.S. Cl. CPC G06Q 30/0276; G06Q 30/0621; G06Q 30/0271; G06Q 30/0201

(57) ABSTRACT

An automated research system, processes, and methods of use is presented. The automated research system, process, and method of use provides sponsors with the ability to view the top-performing graphics and/or advertisements for various products across hundreds of leading sites, marketplaces, and digital advertising channels while seamlessly integrating with various E-Commerce platforms to provide solutions to these issues and more, as well as allowing sponsors to research designs, creations, and advertisements and/or advertisement campaigns for products on the E-Commerce platform with a single mouse click, all of this aggregated into a single, easy to use, integrated interface.

### CROSS-REFERENCE TO RELATED APPLICATIONS

The present application claims priority to U.S. Provisional Patent Application No. 62/890,260 which was filed on Aug. 22, 2019, which is hereby incorporated by reference herein in its entirety, including any figures, tables, or drawings.

### FIELD OF THE DISCLOSURE

This disclosure relates to an automated research system, process and method of use. More specifically and without limitation, this disclosure relates to an automated research system for automticated research of top-performing advertisements (or “ads”), designs, and products.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document: Copyright AutoScale. All rights reserved.

### BACKGROUND OF THE DISCLOSURE

Research is integral in many operations. Advertising is marketing communication that employs an openly sponsored, non-personal message to promote or sell a product, service or idea. Sponsors of advertising are typically businesses wishing to promote their products or services. Advertising is differentiated from public relations in that an advertiser pays for and has control over the message. Advertising is communicated through various mass media, including traditional media such as newspapers, magazines, television, radio, outdoor advertising or direct mail; and new media such as search results, blogs, social media, websites, and even text messages, or mobile alerts. The actual presentation of the message is referred to as an advertisement, or “ad”.

A center-piece of advertising is design. Billions are spent on advertising design because the design and/or graphical representation of an advertisement is often what influences whether a potential consumer becomes a purchaser. For this reason, companies invest great resources into the various designs created to market various products. Additionally, great resources are expended after advertisement campaigns are launched to measure the success of various designs as used in various locations with various products. One example of such advertising and advertising designs are found in digital advertising.

New media, or digital advertising offers many benefits; many of these benefits overcome the deficient and decreasing popularity of traditional advertising. For this reason, digital advertising is quickly becoming the advertising choice for many small businesses, especially those businesses with limited marketing budgets. Digital advertising is prominent in places like social media and search engines, so businesses can get started with advertising campaigns for as little as a few hundred dollars.

For this reason, ads located on social media posts, search engines, YouTube® and elsewhere are preferable. A sponsor (or “user”) can even set up their advertisements in ways that they only pay the host (or advertiser) for clicks actually received. In this way and more, reaching folks through digital advertising methods is often more affordable and preferable.

Another advantage of digital advertising over traditional advertising is that success can be tracked. When a sponsor runs an ad campaign on a digital platform, the sponsor can see how well they are doing in real time. These powerful advertising analytic tools help sponsors and/or businesses determine how to best spend their marketing budgets, and also how to best utilize their marketing budgets. However, even with the analytics tools of today, it is very hard for a regular business owner and/or sponsor to understand how this technology works. Let alone find the time to manage this sophisticated analytical technology.

The development of digital advertisement designs, publications, and customized consumer advertisements and/or advertisement campaigns is often a challenging, complicated, laborious process. The process often involved many authors, editors, proofers, illustrators, artists, and other contributors. The laborious task of developing a single advertisement may include assembling a rough draft from the content of one or more contributors creations, managing edits made by editors, and relying on various proofers to review the works. Finally, the publication process takes time, attention, and labor. Furthermore, monitoring the success of an advertisement on social media, or another digital platform is tricky. Some analytics exist but accessing, interpreting and understanding these analytics often means hiring a digital marketing specialist.

Especially when these tasks fall across geographic regions which may be globally. An editor in India may be working with an author in South America, while the author in South America is working with a publisher in the United States. In this way, authors, editors, proofers, illustrators, artists, marketing specialists, influencers, promotors, and other contributors are faced with having to assimilate the contributions from each of these dispersed contributors. In some cases, different users may use different document format, which adds to the complications. In other cases, a contributor and/or user may not be familiar with the interface of the graphic design creator or may otherwise not be familiar with the inner workings of a program, leading to content creation problems.

Thus, business owners, sponsors, and others wishing to market their products face the challenge of creating each piece of content through this laborious process. This process is a manual process. As one of many examples, inserted here strictly to illustrate the difficulty in content generation, we take the example of creating a single advertisement to promote a single product. In the event a user desires to create this single advertisement, the process is tedious and requires a lot of attention of the user.

One amongst many problems a sponsor may face, different contributors to the creation of the advertisement may use different formats (e.g., contributors may use a word processing format such as Microsoft Word® while a proofer may use Adobe's Portable Document Format or PDF (.pdf).) Therefore, publishers and other contributors to the advertisement creation are faced with the challenge of converting various formats and propagating changes in one format to all the different formats used by various contributors.

Advertisement creation is a manual task which requires close attention so that errors aren't made. For this reason, teams of people are often employed to create a single advertisement or advertisement campaign. Each different brand will face challenges of incorporating a business brand into an advertisement campaign. Thus, this is a laborious and tedious task. Publishers and/or other users also struggle to properly track and manage the various versions and revisions of the advertisements they are working on. This becomes tricky and upsets communication and disrupts tracking problems in the content, and furthermore disrupts tracking resolution of any problems that arise during the process. Publishers and other users also rely almost entirely on manual proofing, which itself is a laborious process. These challenges and others are only exacerbated when the content is in the form of electronic content generation, such as new media types including animation, videos, and the like which would display the media to potential clients, purchasers, or licenses. All of which are very common, and nearly required forms of advertisement material, in today's digital media marketing scheme. This new type of content generation does not easily fit into the existing process or work with existing publishing tools. Below is an example which illustrates some of the difficulties.

Even in new advertising approaches, which use data-driven advertising approaches which use large quantities of data, challenges abound. Interpreting and understanding large quantities of advertising data is difficult. Even the most experienced and seasoned digital advertising specialist have trouble interpreting large quantities of data to make precise and accurate decisions with advertisements or advertising campaigns.

For this reason, bulk online display advertising has become a popular choice for businesses and sponsors. Online bulk display advertising displays ads in levels number the thousands or even hundreds of thousands or millions. In these graphic advertisement displays, an image showing/promoting a product is shown online which also acts as a link to a product. These bulk online advertising methods can generate awareness quickly.

Unliking searching, which requires someone to be aware of a need, display advertising can drive awareness of something new and/or something a purchaser may desire by other indications such as prior searches or other information gathered. This bulk awareness of something new, of a user's products and without previous knowledge can be critical in successfully marketing a product.

Because the advertisement also can act as a link, display advertising works well for direct responses as well. This makes accessing the products and purchasing the products even easier for a consumer. Display advertising is not only used to generate awareness but is used for these kind of direct response campaigns which generate traffic on a sponsor's website which also leads to better search engine results and other cascades of promotion for a sponsor.

Digital advertising has huge benefits for a sponsor. However, the mountain of problems and the number of people involved can quickly harm a sponsor's prospect of digital advertising, delay the process, or end it altogether. The problems, amount of people required, costs of production, and intensity of labor only increase as a second advertisement design is created, a third advertisement design, a fourth advertisement design, and more are added to the task list. When thousands of product advertisements are shown, diversity in the advertisement also becomes an important factor. However, with diversity in the advertisements comes increased cost in having a marketer and/or team of people create such campaigns.

Additionally, many different platforms, sizes, and other marketing challenges face sponsors. An advertisement created for Facebook® may not be sized or work correctly with an advertisement created for another social media platform. Additionally, an advertisement created for a specific target audience in Facebook® may not work for another target audience within the social media platform. Thus, the challenges of various platforms and e-commerce routes also hinder sponsors wishing to succeed in digital advertising.

Similarly to advertisement creation, advertisement monitoring and research is a great challenge for sponsors. For these reasons and more, sponsors and every company that advertises face numerous challenges in advertising and promoting their products. In addition to spending a great amount of resources in creating various advertisements, designs, and associating advertisements with products, companies expend a great amount of resources in researching the success of these various advertisement campaigns. Advertising campaigns cost a great deal of money to maintain. In order to expend resources in the best mode possible, it is important to know which advertisements should be launched as well as which advertisement campaigns should be maintained.

Furthermore, the problems, the amount of people required, costs of production, and intensity of labor only increases as the number of advertisements and/or advertisement campaigns increase. Every advertisement means more research and more expense and labor for someone to monitor and attempt to categorize the information from the monitoring. It is further another task of interpolating any compiled information in a manner that is usable to make future decisions about advertising.

Thus, it is a primary object of this disclosure to provide an automated research system, process, and method of use that provides sponsors with the ability to view the top-performing graphics and/or advertisements for various products across hundreds of leading sites, marketplaces, and digital advertising channels (“platforms”). Additionally, it is a primary object of this disclosure to provide an automated research system, process, and method of use that provides the ability to aggregate these ads and products into one interface (the “Dashboard”) to quickly analyze the top-performing ads and products.

### SUMMARY OF THE DISCLOSURE

An automated research system, process, and method of use that provides sponsors with the ability to view the top-performing graphics and/or advertisements for various products across hundreds of leading sites, marketplaces, and digital advertising channels (“platforms”) is presented herein. The automated research system, process, and method of use integrates with E-Commerce platforms to provide solutions to these issues and more, as well as allows sponsors to research designs, creations, and advertisements and/or advertisement campaigns for products on the E-Commerce platform with a single mouse click. Furthermore, the automated research system, process, and method of use provides the ability to aggregate these ads and products into one interface to quickly analyze top-performing ads and/or products.

The automated research system, process, and method of use can utilize multiple application programming interfaces (“APIs”) to connect to marketplaces and digital ad channels (“Platforms”). The automated research system, process, and method of use provides the ability to view top-performing advertisement graphics (“Ads”) for products (the “Products”) across hundreds of leading sites, marketplaces, and digital ad channels. Furthermore, the automated research system, process, and method of use provides the ability to aggregate these ads and products into one interface to quickly analyze the top-performing ads and products.

Furthermore, the disclosure herein provides a sponsor with the ability to research these ads or advertisement campaigns on several different online advertising platforms, which helps to directing future and/or current advertisement decisions and/or product decisions. Additionally, the disclosure herein also present a way to create connections to link platforms with the application programming interface. The disclosure herein, provides a means for achieving the entire advertising research process of connecting, researching, interpolating results, and making decisions with a single interface providing a 1-click, top-performing research technology; once information has been accorded.

Furthermore, the automated research system, process, and method of use is able to recreate any of the top-performing concepts using 1-click product creation technology. In this way, the automated research system, process, and method of use can analyze and select a single top-selling and/or top-performing concept as inspiration to create hundreds of different versions, each tailored to match a brand it represents, in a matter of minutes, or less, with a single click. This entire process includes researching, recreating, and designing, and is all completed within a single system.

Furthermore, the automated research system, process, and method of use is able to access millions of ads across top industries; including the links to the landing pages and product types of various companies and/or sponsors across these top industries. In this way, the system provides a normalized data output which includes ad data and/or product data. In this way, the system is able to interpolate and display to a user what is trending in advertisements and what is selling the best across leading marketplaces and digital channels.

Furthermore, once the ads and/or advertisement campaigns have launched, the disclosure herein can monitor the performance of the ads and/or advertisement campaigns. In addition to monitoring performance, the disclosure herein can optimize the bids and budgets of the ads and/or advertisement campaigns. Furthermore, the disclosure herein presents a proprietary machine learning technology which can research success and assist the ads and/or advertisement campaigns in sustaining success.

The automated research system, process, and method of use works across multiple advertising channels (marketplaces and digital marketing channels) and/or platforms, such as but not limited to, Facebook.com and Amazon.com. The automated research system, process, and method of use can automatically recreate advertisements and/or advertisement campaigns using the original product and/or product campaign as inspiration, all with just one click of the mouse.

The automated research system, process, and method of use utilizes machine learning technology in a way which selects the appropriate existing advertisements and/or advertisements campaigns from op industries and/or appropriate audiences to which the advertisements and/or advertising campaigns are targeted. Additionally, the system utilizes machine learning technology which configures the bids and budgets of research and subsequently of the advertisements and/or advertisement campaigns to be recreated and/or launched after initial launch. Once launched, the automated research system, process, and method of use continues to monitor the performance of the advertisements and/or advertisement campaigns. Once launched, the automated research system, process, and method of use optimizes bids and budgets for maximum performance for research, while curtailing excessive spending on low-performing advertisements and/or advertisement campaigns. In this way and others, the disclosure herein presents a way to truly incorporate machine learning technology into advertising.

The automated research system, process, and method of use provides artificial intelligence and/or machine learning technology to programmatically confirm that a new design (when a design is recreated) is significantly different than the design concept retrieved originally, for evaluation and/or research. In this way, the automated research system, process, and method of use provides a variety of dynamic templates to produce a variety of textual and visual differences across the advertisements and/or advertisement campaigns. In this way, the automated research system, process, and method of use can create many different advertisements and/or advertisement campaigns for the same products, each with different text and imagery which is significantly different than the original. In this way, the automated research system, process, and method of use can diversify the advertising which is seen by a consumer. The automated research system, process, and method of use can create new templates (configurations for arranging the text and visual content) easily and add these templates to the system itself, all while providing intent research with interpolated data which is easy to read and understand.

Additionally, the automated research system, process, and method of use can do all of this by only a single click of a user (selection of a product) to research, to re-design, re-create, and re-launch advertisements and/or advertisement campaigns. In this way, the disclosure herein resolves a complicated, unintuitive, tedious, and repetitive process of researching, interpolating, designing, creating and launching advertisements and/or advertisement campaigns for a single product and/or multiple products. The automated research system, process, and method of use can provide all of the benefits in a single disclosure, with rapid assimilation of the new brand, and provides for almost instant use with any new design file, which can complete the goals of a user by a single click, once appropriate information is stored and/or linked.

Thus, it is a primary object of the disclosure to provide an automated research system, process, and method of use provides sponsors with the ability to view the top-performing graphics and/or advertisements for various products across hundreds of leading sites, marketplaces, and digital advertising channels while seamlessly integrating with various E-Commerce platforms to provide solutions to these issues and more, as well as allowing sponsors to research designs, creations, and advertisements and/or advertisement campaigns for products on the E-Commerce platform with a single mouse click, all of this aggregated into a single, easy to use, integrated interface.

Another object of the disclosure is to provide an automated research system, process, and method of use that provides an automated process of researching ads, designs, and products.

Yet another object of the disclosure is to provide an automated research system, process, and method of use that utilizes multiple application programming interfaces.

Another object of the disclosure is to provide an automated research system, process, and method of use that connects to marketplaces and/or digital ad channels.

Yet another object of the disclosure is to provide an automated research system, process, and method of use that provides the ability to view ads and/or top-performing ads for products across hundreds of leading sites, marketplaces, and digital ad channels.

Another object of the disclosure is to provide an automated research system, process, and method of use that provides the ability to aggregate these ads and/or products into one interface.

Yet another object of the disclosure is to provide an automated research system, process, and method of use that provides the ability to quickly analyze the top performing ads and/or products.

Another object of the disclosure is to provide an automated research system, process, and method of use that is able to recreate ads and/or product graphics.

Yet another object of the disclosure is to provide an automated research system, process, and method of use that provides the ability to recreate the top-performing advertisement concepts and/or advertisement concept campaigns.

Another object of the disclosure is to provide an automated research system, process, and method of use that provides the ability to analyze and use a top-selling concept as inspiration to create hundreds of different versions of the same advertisement and/or product advertisement.

Yet another object of the disclosure is to provide an automated research system, process, and method of use that can tailor research and/or advertisement creation to a particular brand.

Another object of the disclosure is to provide an automated research system, process, and method of use that works with a single click.

Yet another object of the disclosure is to provide an automated research system, process, and method of use that can access millions of ads across top industries.

Another object of the disclosure is to provide an automated research system, process, and method of use that can access landing pages and product types.

Yet another object of the disclosure is to provide an automated research system, process, and method of use that provides normalized data and product data.

Another object of the disclosure is to provide an automated research system, process, and method of use that can easily interpolate and display useful information.

Yet another object of the disclosure is to provide an automated research system, process, and method of use that can show trends.

Another object of the disclosure is to provide an automated research system, process, and method of use that can show trends for specific marketplaces and/or digital channels.

Yet another object of the disclosure is to provide an automated research system, process, and method of use that can pull data across multiple channels.

Another object of the disclosure is to provide an automated research system, process, and method of use that is able to recreate a product, using the original product as inspiration.

Yet another object of the disclosure is to provide an automated research system, process, and method of use that utilizes machine learning.

Another object of the disclosure is to provide an automated research system, process, and method of use that can confirm a new design is significantly different than the concept utilized for inspiration.

Yet another object of the disclosure is to provide an automated research system, process, and method of use that incorporates all of a particular brand's rules into each new design.

Another object of the disclosure is to provide an automated research system, process, and method of use that provides a connection to a brand database.

Yet another object of the disclosure is to provide an automated research system, process, and method of use that provides a wide array of information about styling, imagery, coloration, and other needs, and/or legal needs of each brand.

Another object of the disclosure is to provide an automated research system, process, and method of use that can be used by a user with no graphic design knowledge.

Yet another object of the disclosure is to provide an automated research system, process, and method of use that incorporates a slack channel.

Another object of the disclosure is to provide an automated research system, process, and method of use that integrates with Amazon.

Yet another object of the disclosure is to provide an automated research system, process, and method of use that integrates various other sites.

Another object of the disclosure is to provide an automated research system, process, and method of use that integrates with AutoDesign.

Yet another object of the disclosure is to provide an automated research system, process, and method of use that integrates with e-commerce platforms.

Another object of the disclosure is to provide an automated research system, process, and method of use that can utilize an application programming interface.

Yet another object of the disclosure is to provide an automated research system, process, and method of use that provides customized advertisement graphics.

Another object of the disclosure is to provide an automated research system, process, and method of use that provides a user with the ability to post advertisements.

Yet another object of the disclosure is to provide an automated research system, process, and method of use that provides a user with the ability to post advertisements on different advertising platforms.

Another object of the disclosure is to provide an automated research system, process, and method of use that designs advertisements.

Yet another object of the disclosure is to provide an automated research system, process, and method of use that creates advertisements.

Another object of the disclosure is to provide an automated research system, process, and method of use that is user friendly.

Yet another object of the disclosure is to provide an automated research system, process, and method of use that is easy to use.

Another object of the disclosure is to provide an automated research system, process, and method of use that is intuitive.

Yet another object of the disclosure is to provide an automated research system, process, and method of use that is not repetitive.

Another object of the disclosure is to provide an automated research system, process, and method of use that allows users to scale existing product advertisements out to hundreds, or more, of different variations.

Yet another object of the disclosure is to provide an automated research system, process, and method of use that can utilize machine learning to learn various rules and/or gain intimate knowledge of the needs of a platform.

Another object of the disclosure is to provide an automated research system, process, and method of use that does not require a user to have advertising knowledge.

Yet another object of the disclosure is to provide an automated research system, process, and method of use that provides rapid assimilation of a platform.

Another object of the disclosure is to provide an automated research system, process, and method of use that improves upon the state of the art.

Yet another object of the disclosure is to provide an automated research system, process, and method of use that is easy to use.

Another object of the disclosure is to provide an automated research system, process, and method of use that is quick and efficient.

Yet another object of the disclosure is to provide an automated research system, process, and method of use that is accurate.

Another object of the disclosure is to provide an automated research system, process, and method of use that is robust.

Yet another object of the disclosure is to provide an automated research system, process, and method of use that provides ongoing machine monitoring.

Another object of the disclosure is to provide an automated research system, processes, and methods of use that provide for information layer extraction.

Yet another object of the disclosure is to provide an automated research system, processes, and methods of use that apply a dataset to an alpha channel layer.

Another object of the disclosure is to provide an automated research system, processes, and methods of use that identifies word clouds and extracts word cloud data.

These and other objects, features, or advantages of the present disclosure will become apparent from the specification and claims.

### BRIEF DESCRIPTION OF THE DRAWINGS

FIG. 1 is a diagram illustrating the automated research system, processes, and methods of use; the diagram illustrating a graphical user interface of an automated research system; the diagram illustrating an accounts feature; the diagram illustrating a home page feature with a plurality of tabs; the diagram illustrating a trending tab; the diagram illustrating a best seller tab; the diagram illustrating a social tab; the diagram illustrating a search tab; the diagram illustrating a trendline feature; the diagram illustrating a report generator feature;

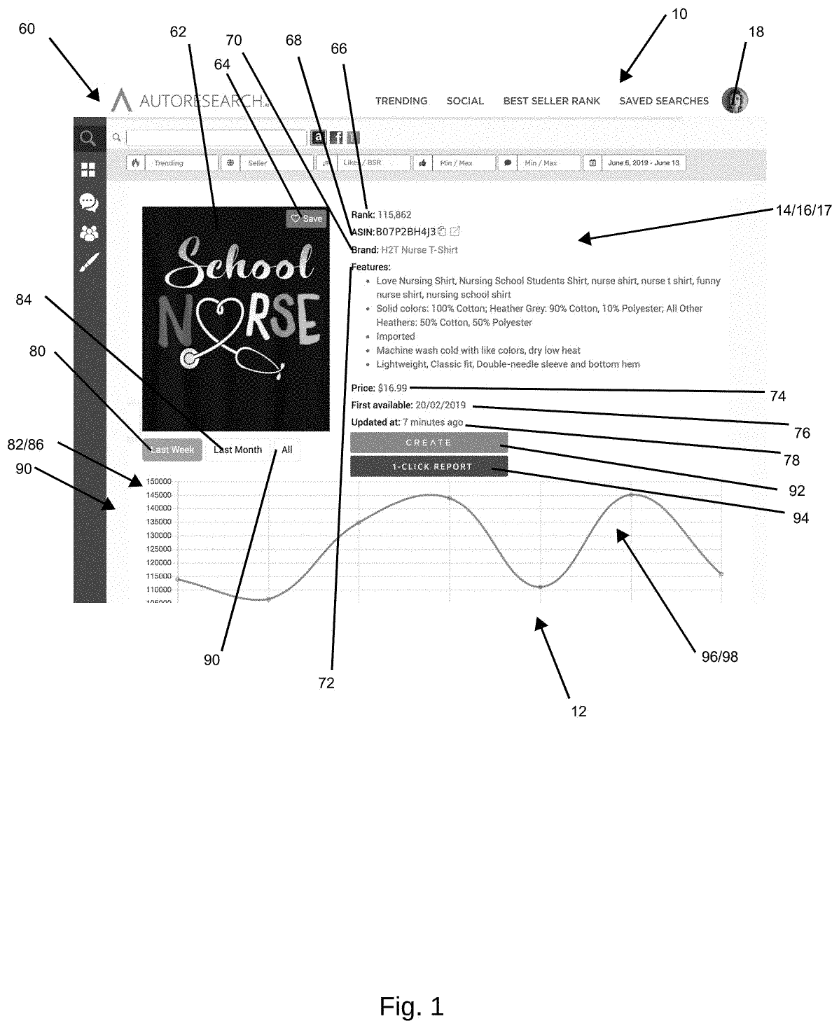

FIG. 2 is a diagram illustrating the automated research system, processes, and methods of use; the diagram illustrating a graphical user interface of an automated research system; the diagram illustrating an accounts feature; the diagram illustrating a home page feature with a plurality of tabs; the diagram illustrating a trending tab; the diagram illustrating a best seller tab; the diagram illustrating a social tab; the diagram illustrating a search tab; the diagram illustrating view trends; the diagram illustrating sale trends;

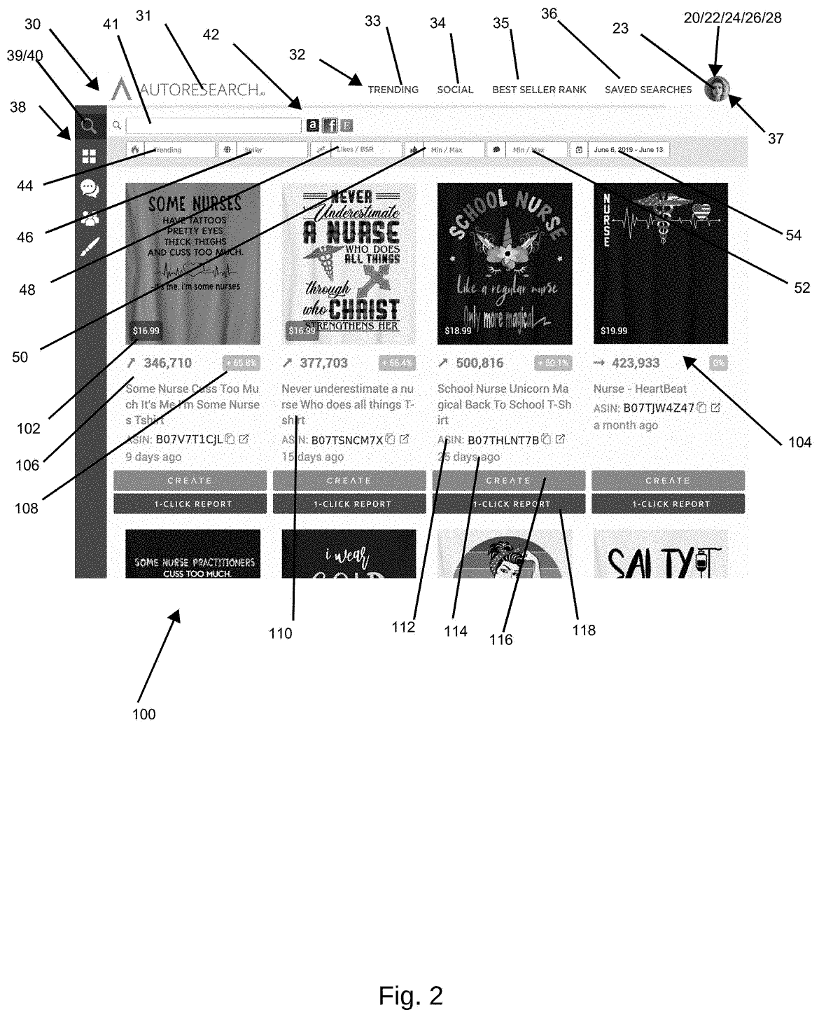

FIG. 3 is a diagram illustrating the automated research system, processes, and methods of use; the diagram illustrating a graphical user interface of an automated research system; the diagram illustrating an accounts feature; the diagram illustrating a home page feature with a plurality of tabs; the diagram illustrating a trending tab; the diagram illustrating a best seller tab; the diagram illustrating a social tab; the diagram illustrating a search tab; the diagram illustrating a design modification feature; the diagram illustrating a design change feature;

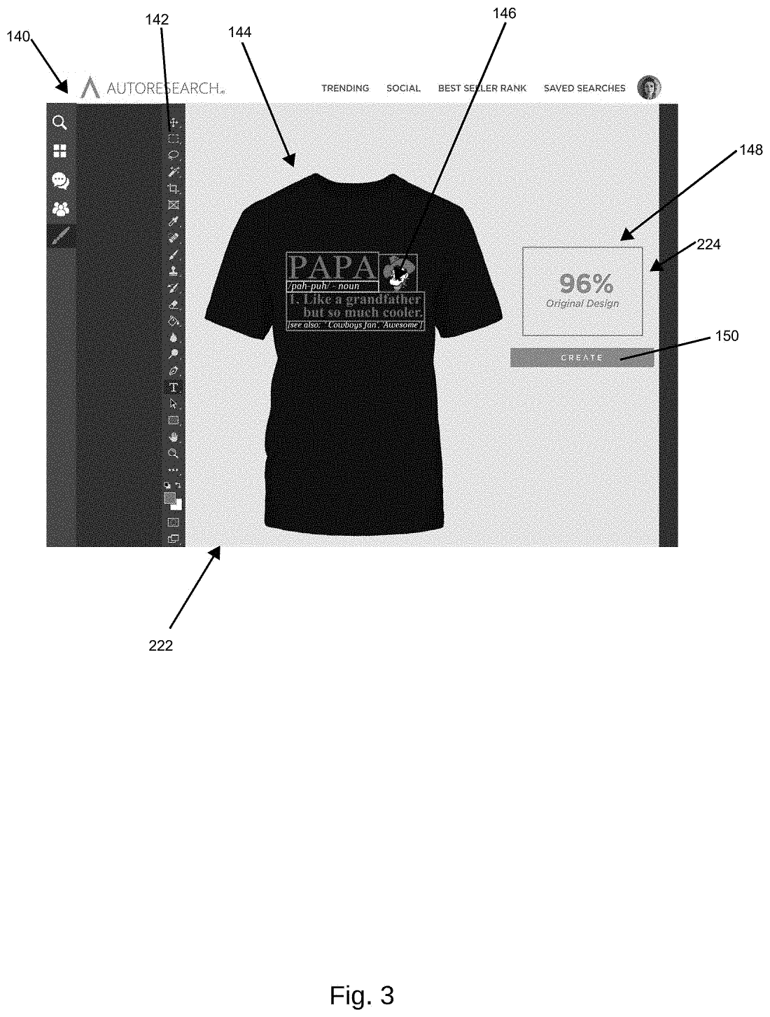

FIG. 4 is a diagram illustrating the automated research system, processes, and methods of use; the diagram illustrating a graphical user interface of an automated research system; the diagram illustrating an accounts feature; the diagram illustrating a home page feature with a plurality of tabs; the diagram illustrating a trending tab; the diagram illustrating a best seller tab; the diagram illustrating a social tab; the diagram illustrating a search tab; the diagram illustrating a trendline feature; the diagram illustrating a report generator feature;

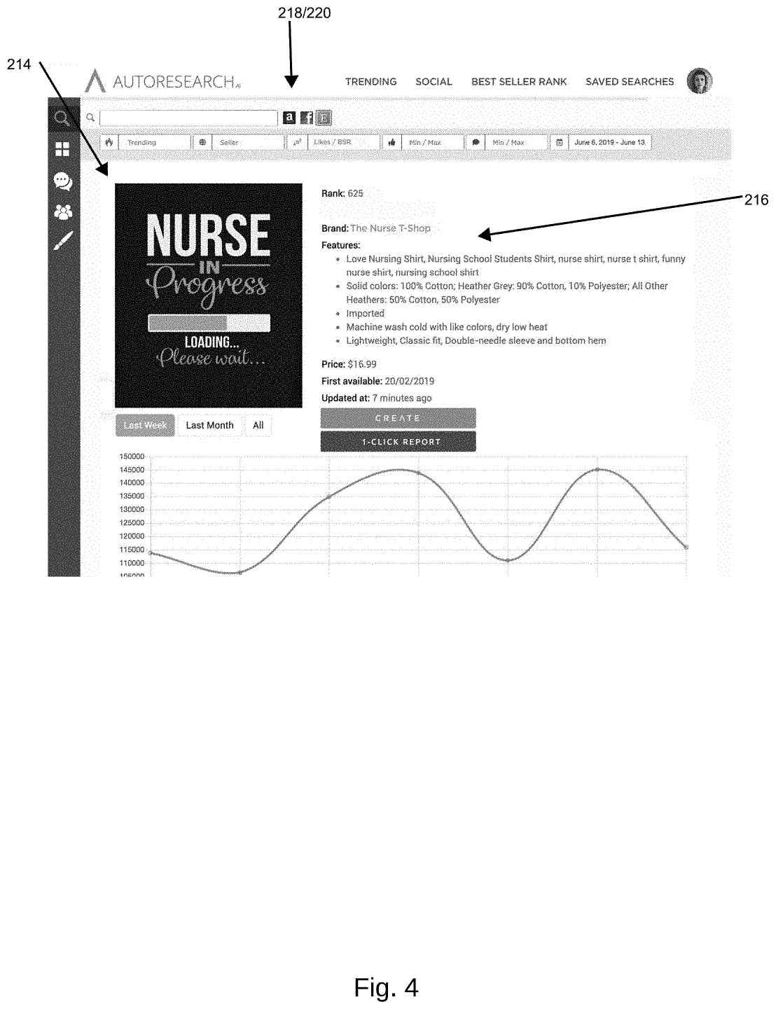

FIG. 5 is a diagram illustrating the automated research system, processes, and methods of use; the diagram illustrating a graphical user interface of an automated research system; the diagram illustrating an accounts feature; the diagram illustrating a home page feature with a plurality of tabs; the diagram illustrating a trending tab; the diagram illustrating a best seller tab; the diagram illustrating a social tab; the diagram illustrating a search tab; the diagram illustrating view trends; the diagram illustrating sale trends;

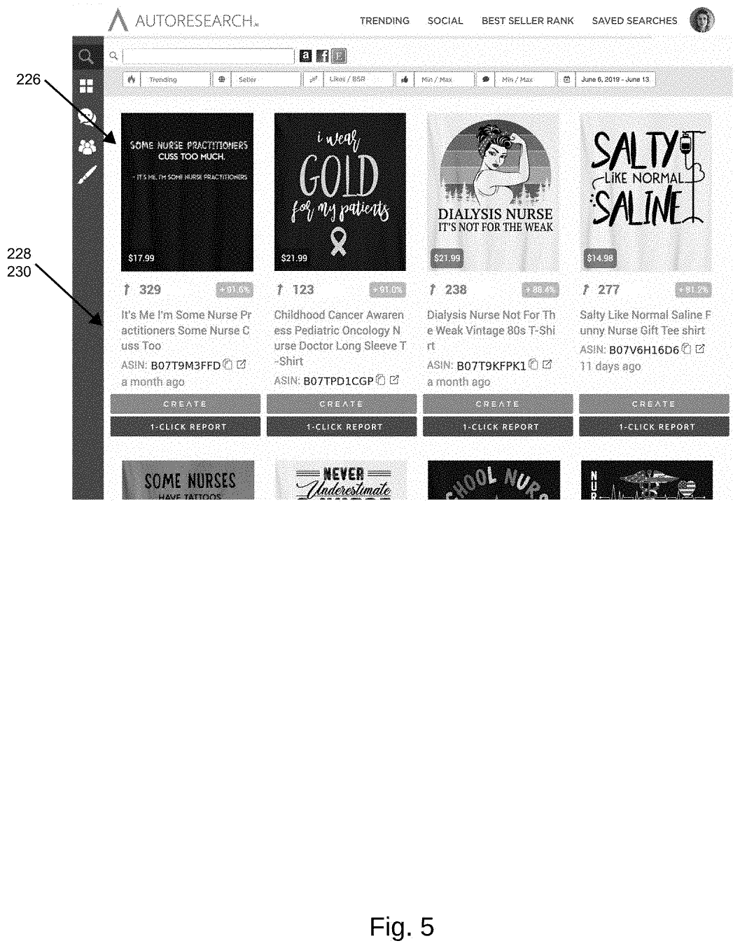

FIG. 6 is a diagram illustrating the automated research system, processes, and methods of use; the diagram illustrating a graphical user interface of an automated research system; the diagram illustrating an accounts feature; the diagram illustrating a home page feature with a plurality of tabs; the diagram illustrating a trending tab; the diagram illustrating a best seller tab; the diagram illustrating a social tab; the diagram illustrating a search tab; the diagram illustrating a trendline feature; the diagram illustrating a report generator feature;

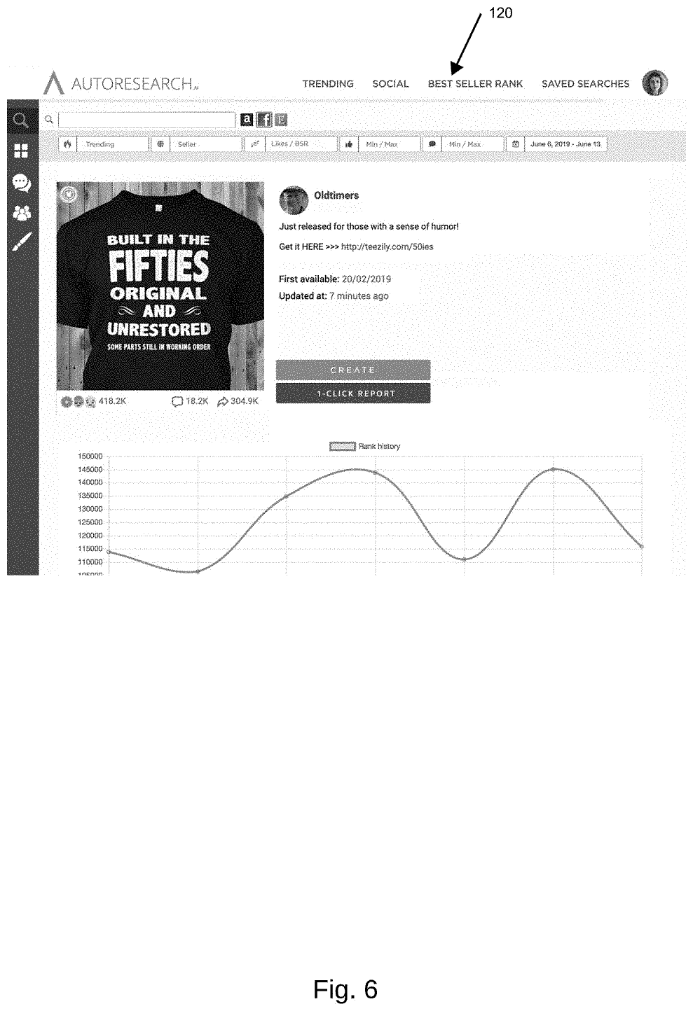

FIG. 7 is a diagram illustrating the automated research system, processes, and methods of use; the diagram illustrating a graphical user interface of an automated research system; the diagram illustrating an accounts feature; the diagram illustrating a home page feature with a plurality of tabs; the diagram illustrating a trending tab; the diagram illustrating a best seller tab; the diagram illustrating a social tab; the diagram illustrating a search tab; the diagram illustrating view trends; the diagram illustrating sale trends;

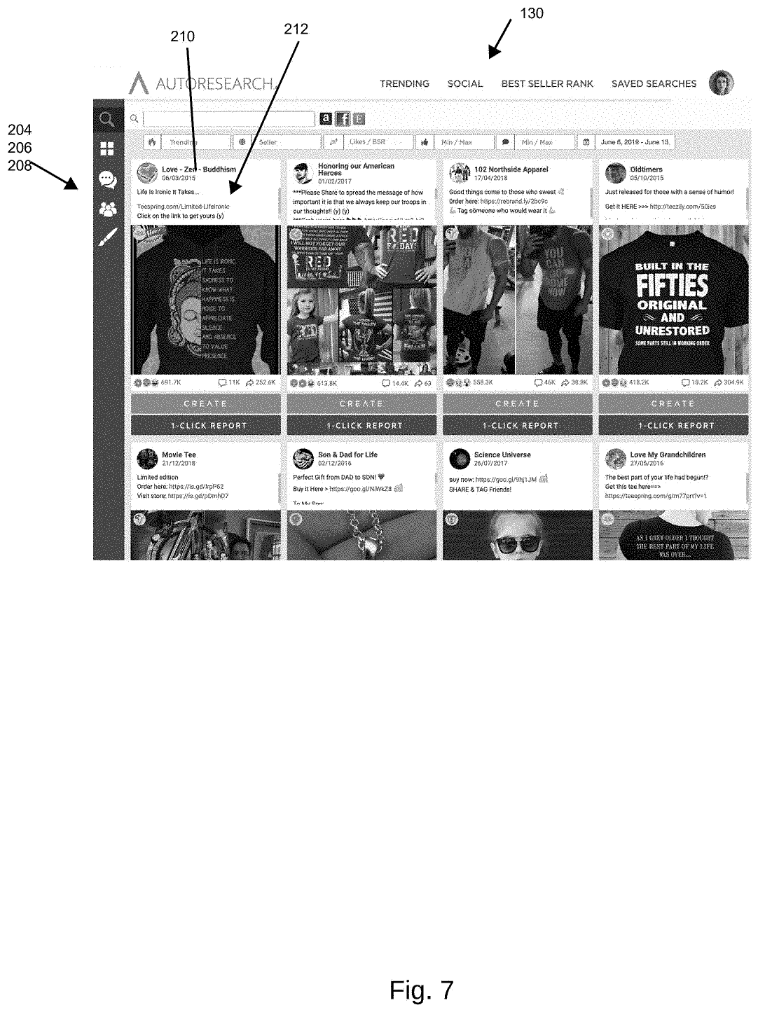

FIG. 8 is a diagram illustrating the automated research system, processes, and methods of use; the diagram illustrating a graphical user interface of an automated research system; the diagram illustrating a report feature; the diagram illustrating a report feature window;

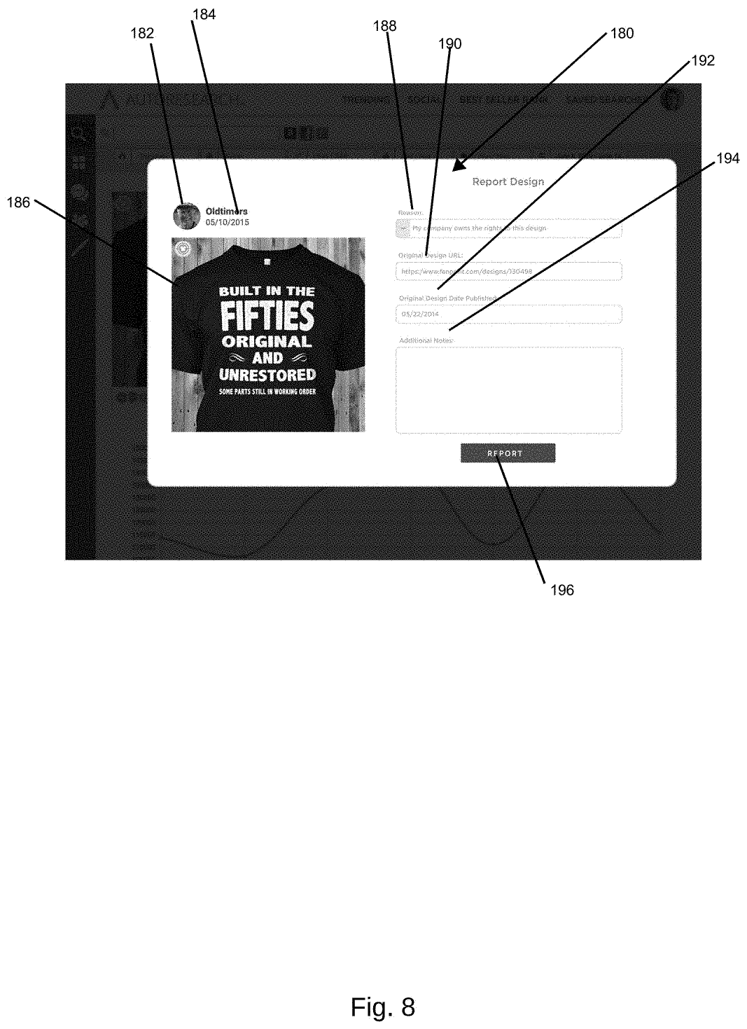

FIG. 9 is a diagram illustrating the automated research system, processes, and methods of use; the diagram illustrating the search and trending process for selection of a research item and report generation.

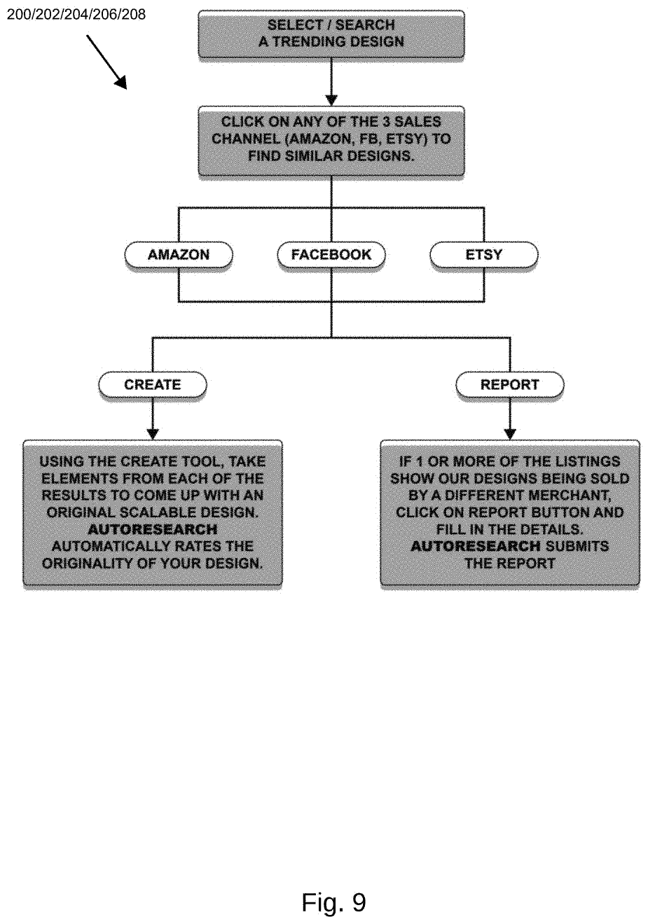

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

Automated research system (also known as “research system”), process and method of use is configured to increase convenience and efficiency for sponsors in researching the success of advertisements and/or the success of a particular design of an advertisement, as well as other metrics such as the success of certain types of creations of advertisements, various data associated with launching, such as time and location of launch, as well as other metrics. The research system helps sponsors maintain and add value to existing advertisements and/or advertisement campaigns. Automated research system is configured to integrate with various platforms and allow a user to track and research advertisements and/or advertisement campaigns. Additionally, research system is designed to aggregate, correlate and interpolate the data gathered into an easily digestible and usable format for a sponsor, by dynamically analyzing different variations of ads and/or advertisement campaigns, based on a product, and different variations of data associated with any ads, campaigns, and/or products. Furthermore, research system can take data gathered from scanning various platforms and generate subsequent ads and/or advertisement campaigns.

Embodiments of the present disclosure includes systems, process, and methods of use that automatically research some or all ad and/or product information on designated industry sites and/or platforms. The embodiments disclosed herein store information gathered and/or data in a comprehensive database containing a myriad of information about the styling, imagery, coloration, and other legal needs of each product and/or brand, as well as, store information related to the timing, location, and other details associated with the advertisement launch.

Furthermore, research system, for the first time, allows a user with no marketing and or marketing research knowledge, to research, comprehend research data, design, create, and launch subsequent advertisements based on other successful ads and/or advertisement campaigns. This research can be performed on one or a plurality of ads. In other words, a user can research thousands of ads and/or advertisement campaigns and/or products on a variety of platforms, simultaneously. The user can cater this research to a specific audience and/or other parameters without having an intimate knowledge of the needs of the brand and/or sponsor. Furthermore, research system can retrieve data for any ad, advertisement campaign and/or product and create a designated input file, automatically generating a dataset based on this item in a database. Subsequently, the research system can identify successful ads and generate subsequent ads with enough similarity to expect to generate a similar success rate.

System:

With reference to the figures, an advertisement creation and publishing system 10, process, and method of use is presented (hereafter known as “advertisement system” or simply “system”). Advertisement system 10 is formed of any suitable size, shape and design. In the arrangement shown, as one example, system 10, which may comprise remote servers, databases, application servers, application databases, application programming interfaces, product databases, mobile applications, and/or computers that fulfill the functions disclosed herein, also includes, in the embodiment depicted, a graphical user interface 12, a database 14, a plurality of datasets 16, a plurality of licenses 17, and accounts 18, among other components.

In the arrangement shown, as one example, system 10 comprises remote servers, databases, and/or computers that fulfill the functions disclosed and described herein. In the embodiment depicted, system 10 comprises an application server 200. Application server 200 comprises one or more computer systems adapted to transmit and receive data regarding selected datasets related to various users and/or datasets related to multiple users. Application server 200 is adapted to query database with unique identification codes to retrieve a list of brand and/or product and/or license rules related to various users. Application server 200 may transmit product data related to layers and rules with respect to a single user and/or multiple users. Application server 200 is also adapted to query a product database 204. This query includes receiving and sending product identification codes and product data. Additionally, the application server 200 may communicate with a mobile application 218, which is adapted to present the product information in a form conducive to being viewed on a mobile device and/or handheld device.

The appearance of the presentation of the product information and/or the process windows for researching hundreds of designs may be customized with data of particular relevance to the customer/or the product and/or the retail store at which the customer is most likely to be researching ads and/or advertisement campaigns and/or products for. As one example, the appearance of windows and/or the process for researching hundreds of designs may be customized for pricing information, trending information, and/or other information related merchandise and/or advertisements.

As one of ordinary skill in the art may understand, application server 200, product database 204, and other databases mentioned herein may be implemented in one or more servers. Furthermore, each may be on multiple servers to increase system efficiency, especially when handling large data gathering, following extended rules for brands and/or user and generating hundreds of designs at once from a single template. Additionally, multiple servers may have mirrored data to prevent data loss in case of disk failure and/or to decrease access and response times for database queries. In alternative embodiments, application server 204, and other database procedures may be carried out on computer-readable instructions and data stored on the customer's mobile computing device. Additionally, system 10 includes an application programming interface 202 (“API”) which includes tools and resources enabling a user to operate the embodiments herein.

Graphical User Interface:

In the arrangement shown, as one example, system 10 includes a graphical user interface 12. Graphical user interface 12 is formed of any suitable size shape and design and is configured to present research data to a user in an easy to use manner. Graphical user interface 12 is designed to represent research data on advertisements and/or advertisement campaign data which can be retrieved and processed. Additionally, graphical user interface 12 provides a user with the ability to upload information to a database as necessary, retrieving product information as necessary, reviewing advertisements, and auto-generating advertisements from a single design template, and create subsequent advertisements from a successful and/or other desired advertisement and/or advertisement campaign. Graphical user interface 12 is an exemplary method by which systems of the present disclosure may research hundreds, if not more, various advertisements 214 and/or advertisement campaigns 226 and/or products. Using graphical user interface 12, a user can research single design with desired products, and determine the effectiveness of advertisements and/or advertisement campaigns.

In the arrangement shown, as one example, graphical user interface 12 includes accounts 18, a plurality of page links 19, a login page 20, a home page 30, an ad/ad campaign, product page 60, a grid page 100, a message page 120, a group page 130, a design page 140, and an infringement report page 180, among other pages, features, and components.

In this arrangement, as one example, a sponsor or other user accesses their account 18 via a login page 20, is the entrance page to the graphical user interface 12. Login page 20 serves the purpose of computer security, and is the page through which a sponsor and/or user gains access to system 10 by identifying and authenticating themselves. In the arrangement shown, as one example, login page 20 includes a display 22, a profile image 23, a username 24, a password 26, a log in 28, among other components.

Home Page: In the arrangement shown, as one example, system 10 also includes a home page 30. Home page 30 is formed of any suitable size, shape, and design and is configured to generally be the main page a user utilizes to navigate the website and/or graphical user interface 12. In addition, and in the arrangement shown, the home page 30 may also serve as a landing page, often times being the first page or a page by which a user lands after logging into their account 18. Additionally, the home page 30 provides a plurality of links to tabs 32 and sub-tabs 38.

Tabs 32 are formed of any suitable size, shape, and design and are configured to give the user a way to navigate the graphical user interface 12. In the arrangement shown, as one example, tabs 32 are arranged along the left of each various page, in a vertical fashion as icons, and are designed to provide visual queues not only to what page the user is on but also to indicate to a user the various ways of selecting research and finding information which is valuable in researching hundreds of ads and/or advertisement campaigns. The plurality of tabs 32 includes a search tab 40, a grid tab, a comment/message tab, a group tab, and a design tab, among other tabs. In the arrangement shown, as one example, the tabs disclosed herein provide links to the associated pages. However, any other number of tabs or arrangement of tabs is hereby contemplated for use.

Ad/Ad Campaign/Product Page: In the arrangement shown, as one example, graphical user interface 12 includes an ad/ad campaign/product page 60 (also known as “product page”). Product page is formed of any suitable size, shape, and design and is configured to serve as one of the main engagement pages. The product page 60 provides a means for a user to interact with various active ads, ad campaigns, and or products that are being sold, via the graphical user interface 12. In this way, a user can see information related to particular products being sold in various formats, as well as, retrieve other information related to various datasets, identify brands, statuses, trends, and other information about the advertisements and the various activity statistics related to the advertisements. In other words, the product page 60 can clearly illustrate to a sponsor what active ad campaigns are live, how those advertisements and/or products are performing and if action should be taken.

In the arrangement shown, as one example, product page 60 may include an ad/campaign/product image 62, a save feature 64, a rank feature 66, an ASIN label 68, a brand identifier 70, features 72, price 74, publication date 76, last update date 78, last week selector 80, last week performance chart 82, last month selector 84, last month performance chart 86, an all time performance selector 88, and all time performance chart 90, a create feature 92, a 1-click report feature 94, a comments feature 96, and a share feature 98, among other options, controls and components.

Grid Page: In the arrangement shown, as one example, graphical user interface 12 includes a grid page 100. Grid page 100 is formed of any suitable size, shape, and design and is configured to provide a list of ads and/or ad campaigns and/or products by which a user can rapidly identify successfully performing advertisement and/or poor performing advertisements and/or rapidly identify other information associated with the advertisements.

In the arrangement shown, as one example, grid page 100 may include a plurality of image identifiers 102 (also known as “ad selectors”), price identifiers 104, trending data 106, change indicator 108, title identifier 110, ASIN identifier 112, publication count feature 114, create feature 116, and 1-click report feature 118, among other options, controls and components.

Design Page: In the arrangement shown, as one example, graphical user interface 12 includes a design page 140. Design page 140 is formed of any suitable size, shape, and design and is configured to provide interaction with the campaign template database as well as create new campaign templates. In other words, the design page 140 provides the user with a means to identify successful advertisements and generate subsequent and different advertisements based on the successful advertisement. Additionally, the design page 140 will automatically generate a subsequent and different advertisement which is projected to be as successful as the original advertisement. Furthermore, a user can edit various features of the subsequently created advertisement and launch the advertisement across various platforms.

In the arrangement shown, as one example, design page 140 may include a plurality of design tools 142, a product 144 (also known as a “product template”), product features 146, a percentage change identifier 148, and a create feature 150, among other options, controls and components.

Infringement Report Window: In the arrangement shown, as one example, graphical user interface 12 may include an infringement report window 180. Infringement report window 180 is formed of any suitable size, shape, and design and is configured to provide to aid a sponsor and/or user in reporting infringing advertisement listings and/or infringing products that have copied the design of the sponsor.

In the arrangement shown, as one example, infringement report window 180 may include a name feature 182, a date feature 184, an image identifier 186, a reason 188, a reason dropdown 189, an original design url identifier 190, an original publication date 192, an additional notes feature 194, and a report submission indication feature 196, among other options, controls and components.

In addition to the above identified features, options, controls, and components, system 10 may also include an application server 200, a plurality of application programming interfaces 202, a product database 204, a dataset 206, data 208, a product identifier 210, a plurality of product characteristics 212, an ad identifier 214, a plurality of ad characteristics 216, a mobile application 218, a platform 220, a design 222, a subsequent design 224, an ad campaign 226, and a plurality of ad campaign characteristics 228, among other options, controls, and components.

In Operation/Method of Use:

An automated research system, process, and method of use for automatically researching multiple advertisements and/or advertisement campaigns for a plurality of products and/or platforms is presented herein. The system 10 presents multiple ways of accomplishing this task and others.

It will be appreciated by those skilled in the art that other various modifications could be made to the device without parting from the spirit and scope of this disclosure. All such modifications and changes fall within the scope of the claims and are intended to be covered thereby.

What is claimed:

1. An automated research system, comprising:
an application server;
a database;
the database having a plurality of datasets;
the datasets having data;
a memory;
a graphical user interface;
the graphical user interface having a research page feature;
the graphical user interface having a research trending feature;
a research item;
the research item having a visual identifier;
the research item having a performance rank;
the research item having a plurality of features;
wherein a user can evaluate a plurality of data from a single campaign template.

2. The system of claim 1, further comprising:
a research trending feature;
a seller rank feature;
wherein the user can monitor a plurality of research trends, a plurality of research data related to a single advertisement template.

3. The system of claim 1, further comprising:
a plurality of trends;
wherein the plurality of trends form a report.

4. The system of claim 1, further comprising:
a report generator;
wherein the report generator feature generates a report based on a particular period of time.

5. The system of claim 1, further comprising:
the research item having a identification number;
the research item having a brand.

6. The system of claim 1, further comprising:
a content management system,
the content management system having a database associated with a plurality of licensing rules;
wherein the plurality of licensing rules are applied to the research and adaptation recommendations of designs.

7. The system of claim 1, further comprising:
an e-commerce platform;
the e-commerce platform having a selling feature;
the e-commerce platform having an upload design feature;
a design distribution feature;
the design distribution feature having a dataset of designs;
wherein the design distribution feature automatically uploads the dataset of designs and launches a set of designs with a predetermined set of rules.

8. The system of claim 1, further comprising:
a variation feature;
the variation feature having a design manipulation rule set;
a content management system;
the content management system having a predetermined set of licensing rules;
a design;
the design having multiple layers;
wherein the design manipulation rule set of the variation feature automatically changes multiple layers of a design in accordance with the predetermined set of licensing rules.

9. The system of claim 1, further comprising:
a design generator;
a graphic design;
a design modifier;
wherein the graphic design is created by the user through the graphical user interface;
the graphic design generated by the design template;
a predetermined set of graphic design rules;
a performance ranking system;
the performance ranking system having a plurality of parameters;
the performance ranking system having a predetermined set of rules for ranking a plurality of parameters;
wherein the design generator produces a plurality of dynamically modified designs based on the set of rules for ranking a plurality of parameters of the performance ranking system.

10. The system of claim 1, further comprising:
a plurality of brands;
the plurality of brands each having a set of licensing rules;
a design modifier;
the design modifier having a predetermined set of rules that adjust with respect to data harvested from research;
wherein the licensing rules are incorporated into the design generator so that designs can be generated which comply with the set of rules for each of the plurality of brands.

11. A design creation, distribution, and publishing system, comprising:
an application server;
a database;
the database having a plurality of datasets;
the datasets having data;
a memory;
a graphical user interface;
the graphical user interface having a research page feature;
the graphical user interface having a research trending feature;
a research item;
the research item having a visual identifier;
the research item having a performance rank;
the research item having a plurality of features;
wherein a user can evaluate a plurality of data from a single campaign template.
a design recommendation feature;
wherein the design recommendation feature recommends design changes based on a set of research results and a predetermined set of rules.

12. The system of claim 11, further comprising:
the e-commerce integration feature having a set of parameters associated with a plurality of e-commerce websites.

13. The system of claim 11, further comprising:
wherein the e-commerce integration feature integrates the design creation system with each of a plurality of e-commerce websites using the set of parameters associated with the respective e-commerce website.

14. The system of claim 11, further comprising:
wherein the e-commerce integration feature integrates the distribution system with each of a plurality of e-commerce websites using the set of parameters associated with the respective e-commerce website.

15. The system of claim 11, further comprising:
wherein the e-commerce integration feature integrates the publishing system with each of a plurality of e-commerce websites using the set of parameters associated with the respective e-commerce website.

16. The system of claim 11, further comprising:
a bulk upload feature;
the bulk upload feature having a plurality of designs;
a plurality of e-commerce platforms;
the plurality of e-commerce platforms having a selectable group;
wherein the plurality of designs are uploaded to the selectable group of the plurality of e-commerce platforms.

17. The system of claim 11, further comprising:
a bulk upload feature;
the bulk upload feature having a plurality of rules;
a plurality of e-commerce platforms;
the plurality of e-commerce platforms having a selectable group;
wherein the plurality of rules are uploaded to the selectable group of the plurality of e-commerce platforms.

18. The system of claim 11, further comprising:
a bulk upload feature;
the bulk upload feature having a plurality of products;
a plurality of e-commerce platforms;
the plurality of e-commerce platforms having a selectable group;
wherein the plurality of products are uploaded to the selectable group of the plurality of e-commerce platforms.

19. A method of automated research, the method comprising the steps:
providing an application server;
providing a product database, the product database having a dataset having data;
providing a graphical user interface;
interacting with the graphical user interface;
providing a set of licensing rules associated with a brand;
providing a set of layers;
integrating the set of licensing rules associated with a brand with the set of layers;
providing recordation of data based on a design;
generating a plurality of research items based on a single product through integration of the set of licensing rules and the set of layers;
modifying a design based on data based on research items.

20. The method of claim 19, further comprising the steps:
providing a bulk upload feature, the bulk upload feature having a plurality of designs;
integrating the bulk upload feature with a plurality of e-commerce platforms having a selectable group;
selecting a set of e-commerce platforms from the plurality of e-commerce platforms;
uploading a bulk set of modified designs to the plurality of e-commerce platforms with a single click.
